(19) United States
(12) Patent Application Publication
(10) Pub. No.: US 2025/0254421 A1
(43) Pub. Date: Aug. 7, 2025

(54) IMAGING APPARATUS, IMAGING SYSTEM, AND IMAGING METHOD

(71) Applicant: FUJIFILM Corporation, Tokyo (JP)

(72) Inventor: Kazuya OKIYAMA, Saitama (JP)

(73) Assignee: FUJIFILM Corporation, Tokyo (JP)

(21) Appl. No.: 19/187,287

(22) Filed: Apr. 23, 2025

Related U.S. Application Data
(63) Continuation of application No. PCT/JP2023/035832, filed on Oct. 2, 2023.

(30) Foreign Application Priority Data
Nov. 16, 2022 (JP) 2022-183397

(51) Int. Cl. H04N 23/667

(52) U.S. Cl. CPC H04N 23/667

(57) ABSTRACT

An imaging apparatus includes a processor configured to set a first imaging parameter that is an imaging parameter in a case where a target object in a real space is imaged to acquire a first image, and a second imaging parameter that is an imaging parameter in a case where a target object in a virtual space is virtually imaged to acquire a second image, acquire the first image based on the first imaging parameter in response to a first imaging instruction operation, transmit an imaging request for a virtual image and the second imaging parameter to a virtual space management server that manages the virtual space, via a communication line, in a virtual imaging mode, receive image data of the second image corresponding to the second imaging parameter from the virtual space management server via the communication line, and output at least the second image to an output device.

### CROSS-REFERENCE TO RELATED APPLICATIONS

The present application is a Continuation of PCT International Application No. PCT/JP2023/035832 filed on Oct. 2, 2023 claiming priority under 35 U.S.C § 119 (a) to Japanese Patent Application No. 2022-183397 filed on Nov. 16, 2022. Each of the above applications is hereby expressly incorporated by reference, in its entirety, into the present application.

### BACKGROUND OF THE INVENTION

### 1. Field of the Invention

The present invention relates to an imaging apparatus, an imaging system, and an imaging method, and particularly to an imaging apparatus, an imaging system, and an imaging method capable of imaging a target object in a real space and a target object in a virtual space.

### 2. Description of the Related Art

For example, JP2020-129272A, JP2020-140383A, and JP2021-101358A are known as techniques for imaging a target object in a virtual space.

### SUMMARY OF THE INVENTION

One embodiment according to the technique of the present disclosure provides an imaging apparatus, an imaging system, and an imaging method capable of performing imaging in a real space and imaging in a virtual space.

An imaging apparatus according to a first aspect of the present invention comprises a processor, in which the processor is configured to set a first imaging parameter that is an imaging parameter in a case where a target object in a real space is imaged by using an imaging optical system and an imaging element to acquire a first image, and a second imaging parameter that is an imaging parameter in a case where a target object in a virtual space is virtually imaged to acquire a second image, and acquire the first image based on the first imaging parameter in response to a first imaging instruction, in which the imaging apparatus transitions to, in a case where a condition set in advance is satisfied, a virtual imaging mode in which an imaging request for the second image and setting of the second imaging parameter are received, and in the virtual imaging mode, the processor is configured to transmit, in a case where a setting instruction of the second imaging parameter is issued, the second imaging parameter subjected to the setting instruction to a virtual space management server that manages the virtual space, via a communication line; transmit at least the imaging request for the second image to the virtual space management server via the communication line in response to a second imaging instruction; receive, from the virtual space management server, image data of the second image corresponding to the transmitted second imaging parameter via the communication line, and cause an image output device to output the second image corresponding to at least the image data. In the first aspect, the device and the like for realizing the function of the imaging apparatus may be housed in one housing, or may be housed in a plurality of separate or separable housings.

In the imaging apparatus according to a second aspect of the present invention, in the first aspect, the processor is configured to set the second imaging parameter in response to an operation on a member for imaging parameter setting, and transmit, in a case where an operation of changing the second imaging parameter is performed on the member for imaging parameter setting, the changed second imaging parameter to the virtual space management server.

In the imaging apparatus according to a third aspect, in the first or second aspect, the processor is configured to set a real parameter implemented by a real imaging optical system provided in the imaging apparatus or a virtual parameter implemented by a virtual imaging optical system virtually provided in the imaging apparatus as the second imaging parameter.

The imaging apparatus according to a fourth aspect, in any one of the first to third aspects, comprises a measurement unit that measures a first imaging position and a first imaging direction of the imaging apparatus in the real space, in which the processor is configured to set a second imaging position and a second imaging direction of the imaging apparatus in the virtual space based on the measured first imaging position and first imaging direction, transmit, to the virtual space management server, information indicating the second imaging position and information indicating the second imaging direction, and receive, from the virtual space management server, image data of the second image corresponding to the second imaging position and the second imaging direction.

In the imaging apparatus according to a fifth aspect, in the fourth aspect, the processor is configured to transmit, in a case where the measured first imaging position and first imaging direction are changed, information indicating the changed second imaging position and information indicating the changed second imaging direction to the virtual space management server.

In the imaging apparatus according to a sixth aspect, in the fourth or fifth aspect, the processor is configured to cause the virtual space management server to fix the second imaging position and the second imaging direction in the virtual space in response to an instruction of a user to the imaging apparatus.

In the imaging apparatus according to a seventh aspect, in any one of the first to sixth aspects, the processor is configured to transmit the imaging request for the second image to the virtual space management server after a determined time has elapsed from issuance of the second imaging instruction.

The imaging apparatus according to an eighth aspect, in any one of the first to seventh aspects, comprises a first storage unit that stores avatar information indicating an avatar of a user of the imaging apparatus, in which the processor is configured to transmit the stored avatar information to the virtual space management server to cause the virtual space management server to display the avatar of the user in the virtual space.

The imaging apparatus according to a ninth aspect, in the eighth aspect, comprises a second storage unit that stores data indicating a three-dimensional shape of the imaging apparatus, in which the processor is configured to transmit the stored data to the virtual space management server to cause the virtual space management server to display the three-dimensional shape of the imaging apparatus in a vicinity of the avatar in the virtual space in association with the avatar.

In the imaging apparatus according to a tenth aspect, in any one of the first to ninth aspects, the second image is a still image or a moving image.

An imaging system according to an eleventh aspect comprises an imaging apparatus and a server connection device, in which the imaging apparatus includes a first processor, the first processor is configured to set a first imaging parameter that is an imaging condition in a case where a target object in a real space is imaged by using an imaging optical system and an imaging element to acquire a first image, and a second imaging parameter that is an imaging condition in a case where a target object in a virtual space is virtually imaged to acquire a second image, and acquire the first image based on the first imaging parameter in response to a first imaging instruction, in which the imaging apparatus and the server connection device transition to, in a case where a condition set in advance is satisfied, a virtual imaging mode in which an imaging request for the second image and setting of the second imaging parameter are received, in the virtual imaging mode, the first processor is configured to transmit, in a case where a setting instruction of the second imaging parameter is issued, the second imaging parameter subjected to the setting instruction to a virtual space management server that manages the virtual space, via the server connection device, and transmit at least the imaging request for the second image to the virtual space management server via the server connection device in response to a second imaging instruction, the server connection device includes a second processor and an image output device, and in the virtual imaging mode, the second processor is configured to transmit, to the virtual space management server, the imaging request for the second image and the second imaging parameter via a communication line, receive, from the virtual space management server, image data of the second image corresponding to the transmitted second imaging parameter via the communication line, and cause the image output device to output the second image corresponding to at least the received image data.

In the imaging system according to a twelfth aspect, in the eleventh aspect, the server connection device is a goggle-type device worn by a user, and includes a display device that displays the second image as the image output device.

The imaging system according to a thirteenth aspect, in the eleventh or twelfth aspect, further comprises the virtual space management server, in which the virtual space management server generates the image data of the second image corresponding to the second imaging parameter in accordance with the imaging request and the imaging condition of the second image received from the server connection device, and transmits the generated image data to the server connection device.

In the imaging system according to a fourteenth aspect, in the thirteenth aspect, the virtual space management server displays the second image in the virtual space in response to an operation of a user of the imaging apparatus.

In the imaging system according to a fifteenth aspect, in the thirteenth or fourteenth aspect, the virtual space management server transmits the image data of the second image generated in response to the imaging request received from one imaging apparatus connected to the virtual space management server, in response to a request from another imaging apparatus connected to the virtual space management server, to the other imaging apparatus.

An imaging method according to a sixteenth aspect is executed by an imaging apparatus including a processor, the imaging method comprising, by the processor, setting a first imaging parameter that is an imaging parameter in a case where a target object in a real space is imaged by using an imaging optical system and an imaging element to acquire a first image, and a second imaging parameter that is an imaging parameter in a case where a target object in a virtual space is virtually imaged to acquire a second image, and acquiring the first image based on the first imaging parameter in response to a first imaging instruction, in which the imaging apparatus transitions to, in a case where a condition set in advance is satisfied, a virtual imaging mode in which an imaging request for the second image and setting of the second imaging parameter are received, and in the virtual imaging mode, by the processor, transmitting, in a case where a setting instruction of the second imaging parameter is issued, the second imaging parameter subjected to the setting instruction to a virtual space management server that manages the virtual space, via a communication line, transmitting the imaging request for the second image to the virtual space management server via the communication line in response to a second imaging instruction, receiving, from the virtual space management server, image data of the second image corresponding to the transmitted second imaging parameter via the communication line, and causing an image output device to output the second image corresponding to at least the image data. The imaging method according to the sixteenth aspect may further comprise the same configurations as those of the second to tenth aspects.

An imaging method according a seventeenth aspect is executed by an imaging system including an imaging apparatus including a first processor, and a server connection device including a second processor and an image output device, the imaging method comprising, by the first processor, setting a first imaging parameter that is an imaging condition in a case where a target object in a real space is imaged by using an imaging optical system and an imaging element to acquire a first image, and a second imaging parameter that is an imaging condition in a case where a target object in a virtual space is virtually imaged to acquire a second image, and acquiring the first image based on the first imaging parameter in response to a first imaging instruction, in which the imaging apparatus and the server connection device transition to, in a case where a condition set in advance is satisfied, a virtual imaging mode in which an imaging request for the second image and setting of the second imaging parameter are received, in the virtual imaging mode, by the first processor, transmitting, in a case where a setting instruction of the second imaging parameter is issued, the second imaging parameter subjected to the setting instruction to a virtual space management server that manages the virtual space, via the server connection device, and transmitting the imaging request for the second image to the virtual space management server via the server connection device in response to a second imaging instruction, and in the virtual imaging mode, by the second processor, transmitting, to the virtual space management server, the imaging request for the second image via a communication line, receiving, from the virtual space management server, image data of the second image corresponding to the second imaging parameter via the communication line, and causing the image output device to output the second image corresponding to at least the received image data.

### BRIEF DESCRIPTION OF THE DRAWINGS

FIG. 1 is a diagram showing a configuration of an imaging system according to a first embodiment.

FIG. 2 is a diagram showing a configuration of a user system according to the first embodiment.

FIG. 3 is a diagram showing a configuration of an imaging apparatus.

FIG. 4 is a diagram showing a functional configuration of a processor of the imaging apparatus.

FIG. 5 is a diagram showing a configuration of goggles.

FIG. 6 is a diagram showing a configuration of a virtual space management server.

FIG. 7 is a flowchart showing processing of an imaging method according to the first embodiment.

FIG. 8 is a flowchart (continuation of FIG. 7) showing the processing of the imaging method according to the first embodiment.

FIG. 9 is a diagram showing a scene in which avatars and a three-dimensional shape of the imaging apparatus is displayed in a virtual space.

FIGS. 10A and 10B are diagrams showing an example in which a mode transitions by a user's motion.

FIG. 11 is a diagram showing a state in which a virtual live view image is displayed on the goggles.

FIGS. 12A and 12B are diagrams showing a scene in which a second imaging parameter is set or changed in the virtual space.

FIG. 13 is a diagram showing an example of the virtual live view image in a case where a focal length of the imaging apparatus is changed.

FIG. 14 is a diagram showing an example of the virtual live view image in a case where exposure is changed.

FIG. 15 is a diagram showing a scene in which virtual images are exhibited in the virtual space.

FIGS. 16A and 16B are diagrams showing a scene of fixation of an imaging position and an imaging direction in the virtual space.

FIGS. 17A and 17B are diagrams showing a scene of imaging using a self-timer function.

FIGS. 18A, 18B, 18C, 18D, and 18E are other diagrams showing the scene of imaging using the self-timer function.

FIG. 19 is a diagram showing a modification example of the user system.

FIG. 20 is a diagram showing a configuration of a user system according to a second embodiment.

FIG. 21 is a diagram showing a configuration of an imaging apparatus according to the second embodiment.

### DESCRIPTION OF THE PREFERRED EMBODIMENTS

One embodiment of an imaging apparatus, an imaging system, and an imaging method according to the present invention is as follows. In the description, accompanying drawings will be referred to as necessary.

### First Embodiment

### [Configuration of Imaging System]

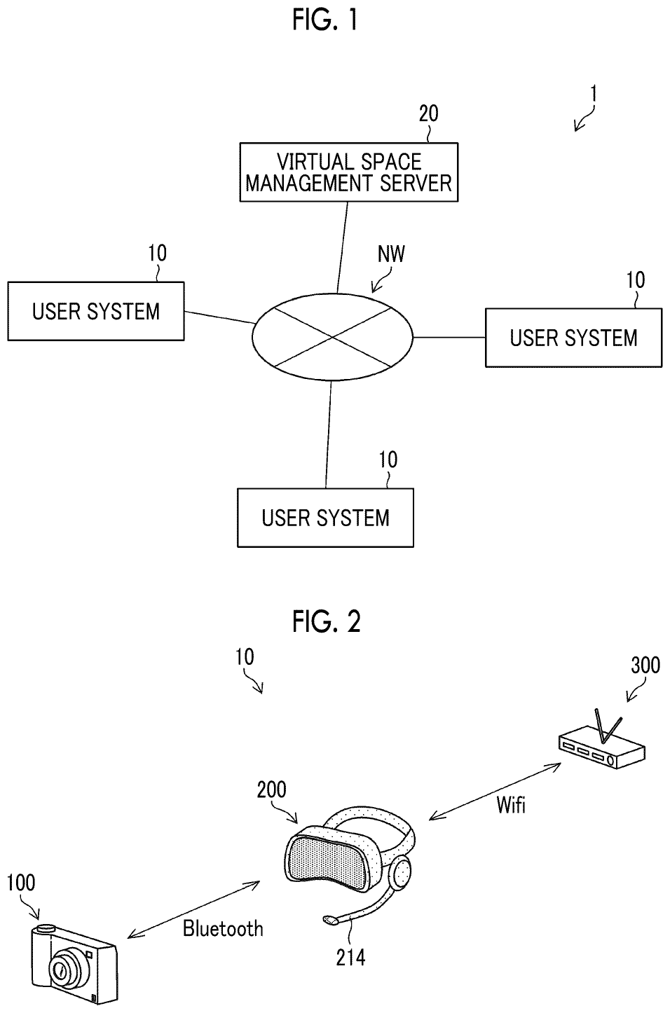

FIG. 1 is a diagram showing a configuration of an imaging system according to a first embodiment. As shown in FIG. 1, an imaging system 1 (imaging system) comprises a user system 10 (imaging system) and a virtual space management server 20 (virtual space management server), and these are connected via a network NW (communication line) such as the Internet. The user system 10 may be one, or may be plural.

### [Configuration of User System]

FIG. 2 is a diagram showing a configuration of a user system according to the first embodiment. As shown in FIG. 2, the user system 10 comprises an imaging apparatus 100 (imaging apparatus), goggles 200 (server connection device, goggle-type device), and a router 300, and the goggles 200 are connected to the network NW via the router 300. The imaging apparatus 100 and the goggles 200 can be connected by wired communication or wireless communication such as Bluetooth (registered trademark), and the goggles 200 and the router 300 can be connected by wired communication or wireless communication such as Wi-Fi (registered trademark).

### [Configuration of Imaging Apparatus]

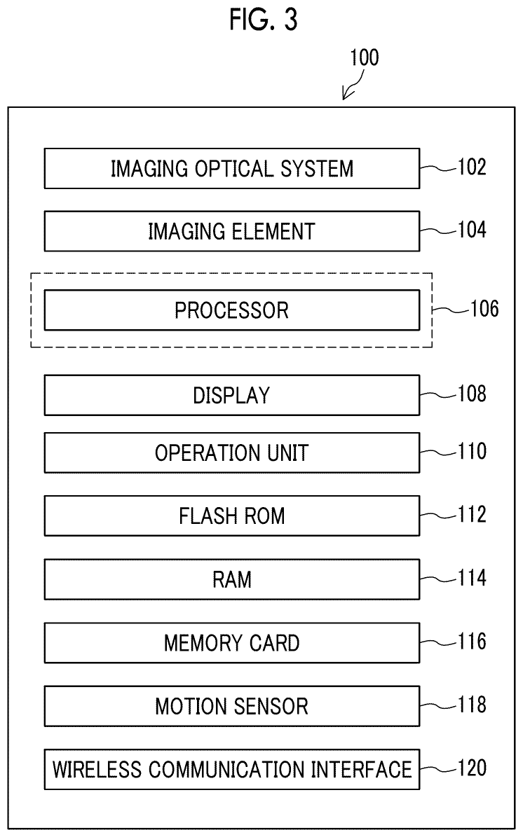

FIG. 3 is a block diagram showing a configuration of the imaging apparatus 100. As shown in FIG. 3, the imaging apparatus 100 comprises an imaging optical system 102 (imaging optical system, real imaging optical system), an imaging element 104 (imaging element), a processor 106 (processor), a display 108 (display device), an operation unit 110 (member for imaging parameter setting), a flash ROM (ROM is read only memory; non-transitory and tangible recording medium), a RAM 114 (RAM is random access memory), a memory card 116, a motion sensor 118 (measurement unit), and a wireless communication interface 120.

The imaging optical system 102 comprises an optical member such as a stop in addition to lenses (an image forming lens, a zoom lens, a focus lens, and the like) (not shown), and forms an optical image of a subject (target object) present in a real space on the imaging element 104. As will be described in detail below, a real image (first image; still image or moving image) of the subject is generated from the optical image by processing in the processor 106. Various imaging elements such as a complementary metal-oxide semiconductor (CMOS) type and a charge-coupled device (CCD) type can be used as the imaging element 104. The display 108 can display the generated real image. The display 108 is configured of a device such as a liquid crystal monitor.

The operation unit 110 is configured of an operation member such as a release button, a cross button, a MENU/OK button, a dial, a switch, and a lever for self-timer setting, and can be commonly used for setting of a first imaging parameter, which is an imaging parameter in a case of acquisition of a real image, and setting of a second imaging parameter, which is an imaging parameter in a case of acquisition of a virtual image. The setting of the imaging parameter will be described in detail below. Further, the operation unit 110 can also be used for an operation such as an imaging instruction (image acquisition request) and self-timer setting.

Configurations and functions of the processor 106, the flash ROM 112, and the RAM 114 will be described below.

The memory card 116 is a non-transitory and tangible recording medium capable of being attached to and detached from the imaging apparatus 100 or inserted into and pulled out from the imaging apparatus 100, and can record information, such as the captured real image (first image) or the virtual image (second image). The memory card 116 can be configured by using, for example, a flash memory as a storage element. The flash ROM 112 (first storage unit, second storage unit) and/or the memory card 116 (first storage unit, second storage unit) may store avatar information indicating an avatar of a user of the imaging apparatus and data indicating a three-dimensional shape of the imaging apparatus.

The motion sensor 118 comprises a sensor such as an acceleration sensor and an angular velocity sensor, and can output information indicating an imaging position (first imaging position) and an imaging direction (first imaging direction) of the imaging apparatus 100 in the real space. The imaging apparatus 100 may be provided with a global positioning system (GPS) receiver, in addition to the sensors.

The wireless communication interface 120 comprises an antenna for wireless communication, such as Bluetooth (registered trademark), and is used for communication with the goggles 200.

### [Processor of Imaging Apparatus]

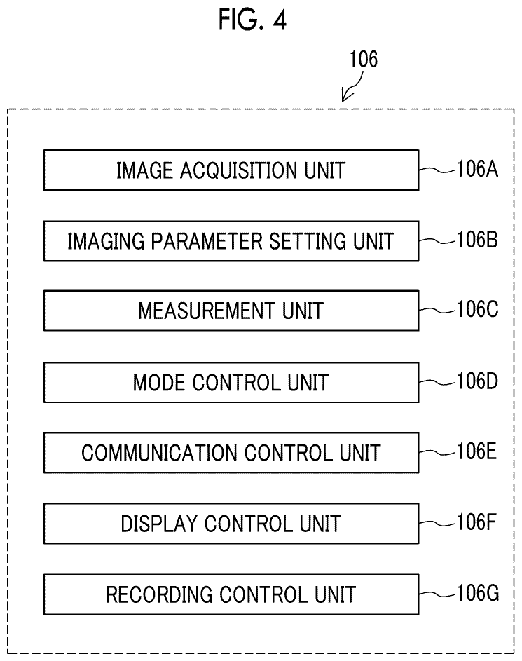

FIG. 4 is a diagram showing a functional configuration of the processor 106 (processor, first processor) of the imaging apparatus 100. As shown in FIG. 4, the processor 106 has functions as an image acquisition unit 106A, an imaging parameter setting unit 106B, a measurement unit 106C, a mode control unit 106D, a communication control unit 106E, a display control unit 106F, and a recording control unit 106G. In a case where the imaging apparatus 100 includes the GPS receiver, the processor 106 may have a function as a positioning unit that performs positioning based on a GPS signal.

The processor 106 is configured of, for example, various processors, such as a central processing unit (CPU), a graphics processing unit (GPU), a field programmable gate array (FPGA), and a programmable logic device (PLD), or an electric circuit. In a case where these processors and the electric circuit execute software (program), a code of the executed software, which is readable by a computer (for example, various processors or electric circuit configuring processor and/or combinations thereof), is stored in a non-transitory and tangible recording medium, such as the flash ROM 112, and the computer refers to the software. The software stored in the non-transitory and tangible recording medium includes an imaging program according to the present invention (program for executing imaging method according to the present invention) and data used in executing the imaging program. The code may be recorded on a non-transitory and tangible recording medium, such as a ROM or an electronically erasable and programmable read only memory (EEPROM), instead of the flash ROM 112. The term “non-transitory and tangible recording medium” does not include a non-tangible recording medium, such as a carrier wave signal or a propagation signal itself, (the same applies to processor 202 and processor 22 described below). In a case of processing using the software, the RAM 114 is used as a temporary storage area or a work area.

Details of the processing using the processor 106 having the above configuration will be described below.

### [Configuration of Goggles]

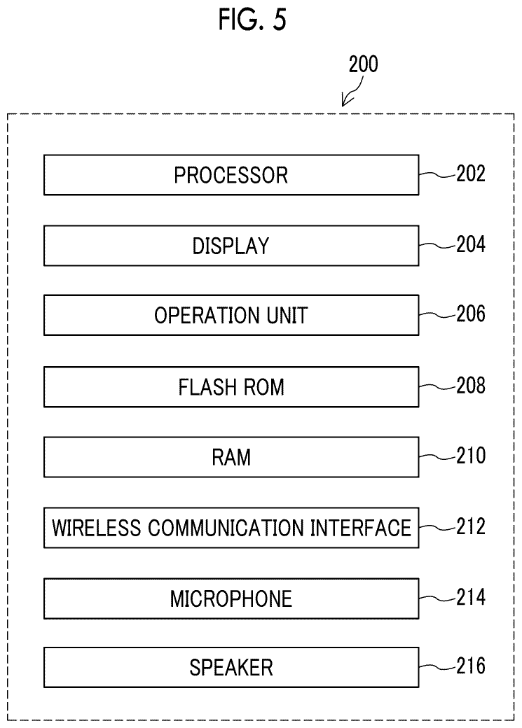

FIG. 5 is a diagram showing a configuration of the goggles 200. As shown in FIG. 5, the goggles 200 comprise the processor 202, a display 204, an operation unit 206, a flash ROM 208, a RAM 210, a wireless communication interface 212, a microphone 214, and a speaker 216, and perform communication with the imaging apparatus 100 and communication with the virtual space management server 20 via the router 300 and the network NW. That is, the goggles 200 functions as the server connection device and an image display device (image output device) of the virtual image, and thus can be configured as a virtual reality (VR) goggles-type device that is worn on the head by the user. The goggles 200 may further comprise a memory card and/or a motion sensor.

The processor 202 (processor, second processor) of the goggles 200 can be configured by using a CPU, a GPU, and the like, in the same manner as described above for the processor 106 of the imaging apparatus 100, and executes various programs such as the imaging program according to the present invention (program for executing imaging method according to the present invention). A program or data stored in the flash ROM 208 can be used in the execution, and the RAM 210 can be used as a temporary storage area or a work area in the processing.

The display 204 is used to display various types of information such as the virtual image (second image), the imaging parameter, an operation menu, and a message to the user. Further, in regard to operations of setting of the imaging parameter (second imaging parameter), switching (transition) of an imaging mode, an imaging request, image display, and the like, the operation unit 206 of the goggles 200 for the virtual image may be used in combination with the operation unit 110 of the imaging apparatus 100. Even in a case where the operation unit 110 of the imaging apparatus 100 is difficult to be operated due to covering of surrounding of the eyes with the goggles 200, it is possible to improve the operability with the use of the operation unit 110 and the operation unit 206 in combination.

Further, in the goggles 200, it is possible to perform an operation by a voice input via a microphone 218 and a speaker 220, to listen to a sound in a virtual space, and to have a conversation with another user connected to (participating in) the virtual space. The message to the user may be output via the devices. The processor 202 can perform voice recognition on a voice input via the microphone 218.

Details of the processing using the goggles 200 having the above configuration will be described below.

### [Configuration of Virtual Space Management Server]

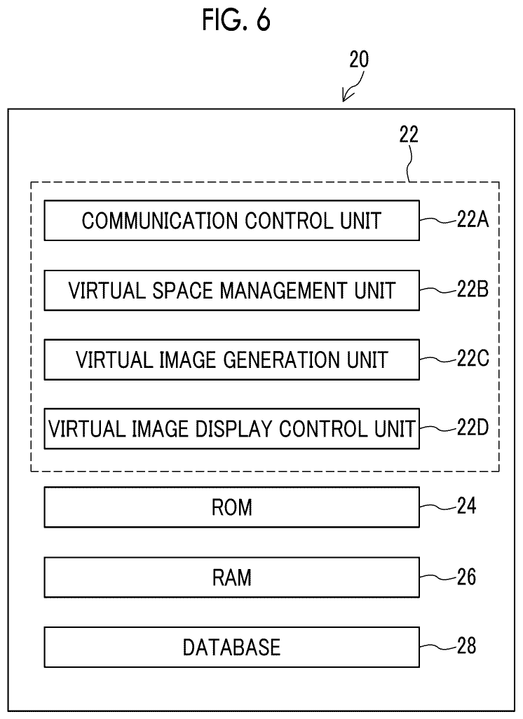

FIG. 6 is a diagram showing a configuration of the virtual space management server 20 (virtual space management server). As shown in FIG. 6, the virtual space management server 20 comprises the processor 22 (processor, third processor), a ROM 24, a RAM 26, and a database 28, and manages a position of an object or an avatar in the virtual space, a voice and lighting (brightness, chroma saturation, and the like) in the virtual space, a change thereof, and the like.

The processor 22 can be configured by using a CPU, a GPU, and the like, in the same manner as described above for the processor 106 of the imaging apparatus 100 and the processor 202 of the goggles 200, and executes various programs such as the imaging program according to the present invention (program for executing imaging method according to the present invention). A program or data stored in the ROM 24 (non-transitory and tangible recording medium) can be used in the execution, and the RAM 26 can be used as a temporary storage area or a work area in the processing. Further, the database 28 comprises various magneto-optical recording devices, semiconductor recording devices, and the like (non-transitory and tangible recording media), and can record and output various types of information (environment setting information of the virtual space, disposition of objects, user accounts, and the like) necessary for managing the virtual space.

### [Imaging in Imaging System]

In the imaging system 1 having the above configuration, it is possible to capture the real image (first image) and the virtual image (second image), as will be described below.

### [Acquisition of Real Image]

The imaging apparatus 100 can acquire the real image, in the same manner as a general imaging apparatus. For example, the processor 106 (processor, first processor) of the imaging apparatus 100 sets the first imaging parameter, which is an imaging condition in a case where the target object in the real space is imaged to acquire the real image (first image), in accordance with the operation of the user. The first imaging parameter may include at least one of a focal length, a focusing distance, a shutter speed, an F number, or image quality, and may additionally include an imaging mode (imaging scene), presence or absence of image processing and contents thereof, presence or absence of electronic flash light, and the like. Further, the term “image quality” may include at least one of a resolution, a sharpness, an International Organization for Standardization (ISO) sensitivity, or a white balance, and may further include items that can be set in the imaging of the real image, such as film simulation, a tone, a chroma saturation, a contrast, a hue, a noise, a dynamic range, and a brightness (the same applies to virtual image described below).

The user can perform the setting operation of the first imaging parameter on the dial, the button, or the like (not shown) of the operation unit 110. The setting operation may be a zoom operation and/or a focus operation (for example, rotation, moving forward/backward, or the like of a zoom ring or a focus ring in a lens barrel) on the imaging optical system 102, or may be an operation via a touch panel in a case where the display 108 is a touch panel type.

The imaging apparatus 100 can acquire the real image (first image) by imaging the target object in the real space using the imaging optical system 102 and the imaging element 104, based on the first imaging parameter, in response to an operation (first imaging instruction, imaging request) such as pressing of the release button (not shown) by the user.

### [Capturing of Virtual Image]

### [Basic Aspect of Virtual Image Capturing]

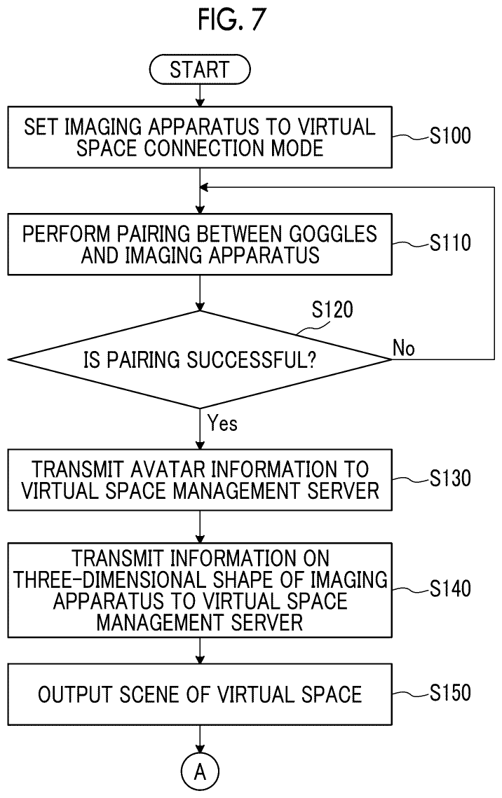

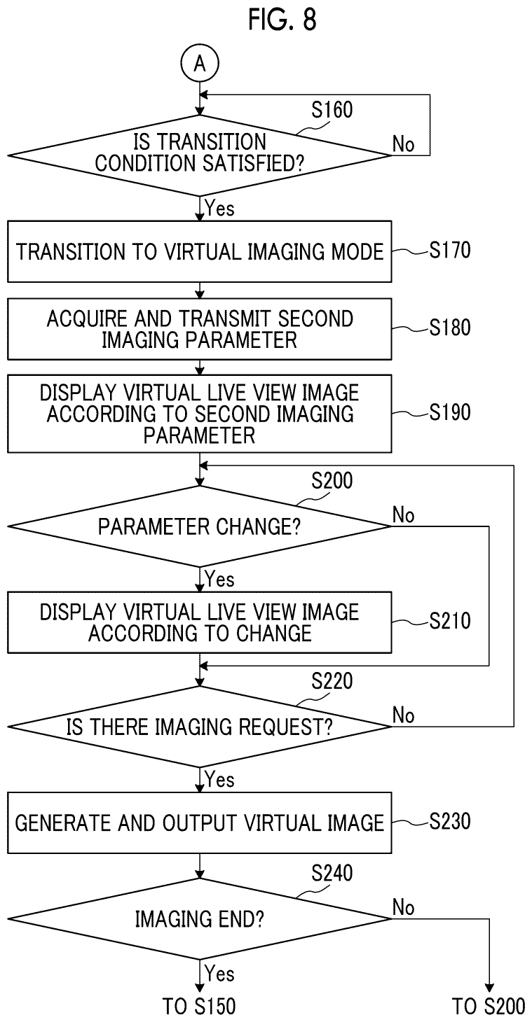

FIGS. 7 and 8 are flowcharts showing a procedure of a basic aspect of virtual image capturing.

### [Pairing of Imaging Apparatus and Goggles]

The mode control unit 106D (processor 106) sets the imaging apparatus 100 to a virtual space connection mode, and the processor 202 sets the goggles 200 to the virtual space connection mode (step S100). A trigger (cause) of the setting may be, for example, detection of the operation on the operation unit 110, detection of a predetermined motion (shaking the imaging apparatus 100, or the like) by the motion sensor 118, detection of the operation on the operation unit 206, and recognition of a voice input to the microphone 214 (the processor 202 of the goggles 200 is assumed to have a voice recognition function in this case).

In a case where the imaging apparatus 100 and the goggles 200 are set to the virtual space connection mode, the mode control unit 106D and the processor 202 perform pairing between the imaging apparatus 100 and the goggles 200 (step S110). The communication between the imaging apparatus 100 and the goggles 200 can be performed by wireless communication, such as Bluetooth (registered trademark), via the wireless communication interface 120 and the wireless communication interface 212, and the pairing processing is the same as pairing between a personal computer (PC) or a smartphone and a peripheral device (printer, speaker, earphone, or the like). In a case where the pairing is successful (YES in step S120), the processing proceeds to step S130. Hereinafter, the imaging apparatus 100 acts as a controller of the goggles 200. In the example of FIG. 7, the pairing is repeated until the pairing is successful (until YES in step S120), but the processing may be ended in a case where the pairing is not successful within a determined number of times or a determined time.

### [Transmission of Avatar Information]

In a case where the pairing is successful in step S120, the user system 10 transmits, to the virtual space management server 20, the avatar information indicating the avatar of the user of the imaging apparatus 100 (step S130). Specifically, the communication control unit 106E (processor 106) and the processor 202 transmit the avatar information to the virtual space management server 20 via the goggles 200 (server connection device) and the router 300 (step S130). As described above, the avatar information can be stored in the flash ROM 112 (first storage unit) and/or the memory card 116 (first storage unit). The avatar information may be created by the user or may be downloaded (purchased). Further, the avatar may be a representation of a human body, an animal, a plant, or another thing. The avatar may have “emotion” or “expression” of the user, or an attribute corresponding to “emotion” or “expression”.

In the imaging system 1, the motion sensor 118 or the like of the imaging apparatus 100 detects a motion of the user, and thus the avatar can reflect the motion to change a position or a posture in the virtual space. Further, in order to accurately reflect a user's motion on the avatar, the user system 10 may further comprise a motion sensor (acceleration sensor, angular velocity sensor, or the like) that is attached to the hands and feet of the user. In the user system 10, the motion sensors can be configured to communicate with the virtual space management server 20 via the goggles 200 (server connection device).

### [Transmission of Three-Dimensional Shape Data of Imaging Apparatus]

### [Significance of Three-Dimensional Shape Data]

In recent years, in the virtual space (virtual reality space, VR space), photographing of a person, a landscape, or the like in the virtual space has been established as one use case, and three-dimensional shape data of a digital camera (imaging apparatus) that can be used for the avatar in the virtual space has been required. Under such circumstances, a polygon model of the digital camera present in the real space has begun to be provided as an item in the virtual space, but the model is a low polygon model as a tool for decorating the avatar in the virtual space. From this movement, it is considered that in the future, there will be a change in the avatar in the virtual space from being a property of a specific platformer to being a property of an individual, the item for dressing up the own avatar will be owned as the asset of the individual, and the distribution of various things (articles) that are present around us in real life, in addition to the camera, as data in the virtual space will be accelerated. In the present embodiment, in consideration of such a situation, the three-dimensional shape data of the imaging apparatus 100 can be displayed in the virtual space.

The communication control unit 106E (processor 106; first processor) transmits data indicating the three-dimensional shape of the imaging apparatus 100 to the virtual space management server 20 via the goggles 200 (server connection device), the router 300, and the network NW (communication line) (step S140). The three-dimensional shape data can be stored in the flash ROM 112 (second storage unit) and/or the memory card 116 (second storage unit). The communication control unit 106E can transmit the three-dimensional shape data using, for example, a web application programming interface (API). It is preferable that the Web API communicates state information of the imaging apparatus 100 (ON/OFF state of power, inclination information (posture around three axes), focus and zoom information, release state, and the like) and the second imaging parameter, in addition to the three-dimensional shape data.

A company that manufactures and sells the imaging apparatus 100 can provide the three-dimensional shape data. As will be described below in a section of “Configuration of virtual space”, the user may be able to obtain the data in the virtual space. Further, the three-dimensional shape data may accurately indicate a shape, size, color, texture, and the like of the imaging apparatus 100, or may be different from the real imaging apparatus 100 such as the imaging apparatus 100 being expressed in a pseudo or deformed manner. For example, in a case where the real imaging apparatus 100 is a popular or low-priced apparatus, data of a real high-end apparatus or data for causing the high-end apparatus to be imagined is displayed, and thus it is possible to satisfy a user's request of “high-end camera is desired to be owned in the virtual space”. Data of a model that is not actually present (model that is present only in the virtual space) may be employed. Further, a brand name and/or a logo mark of the imaging apparatus 100 may be displayed in the three-dimensional shape data. With these displays, it is possible to satisfy a user's desire of ownership and exhibit an advertising effect of a manufacturer or a seller.

### [Configuration of Virtual Space]

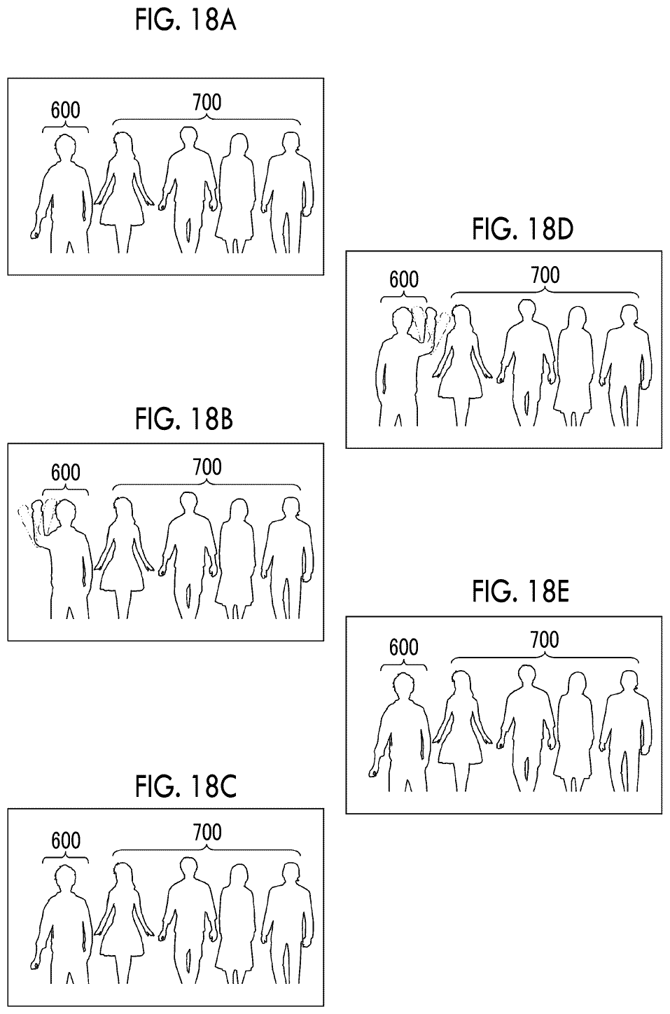

The virtual space may be a single space, or may be divided into a plurality of spaces (for example, a personal room or a conference room, a virtual store such as a retail store or a restaurant, a facility such as a live venue, and a city). Further, the virtual space management server 20 may provide, in the virtual space, “virtual store in which the user can obtain (download, purchase, or the like; the same applies hereinafter) information indicating an avatar” or “virtual store in which three-dimensional shape data of an imaging apparatus is displayed or exhibited and the user can obtain the data”, “virtual exhibition room in which a captured virtual image or a virtual printed matter thereof is exhibited and the user can obtain the image” (refer to FIGS. 18A to 18E), and the like, which will be described below.

### [Output of Scene of Virtual Space]

A communication control unit 22A and a virtual space management unit 22B (third processor) of the virtual space management server 20 transmit a scene of the virtual space to the user system 10 via the network NW (communication line), and cause the goggles 200 (image output device) to output the scene (step S150). The term “scene of virtual space” may include a sound and illumination (brightness, chroma saturation, and the like) in the virtual space and a temporal change of these, in addition to positions, shapes, and motions of a background, an object, and an avatar in the virtual space, and the term “output” may include the display on the display 204 (image output device, image display device) and a sound output from the speaker 216. The communication control unit 22A and the virtual space management unit 22B may display an avatar of another user participating in the virtual space, in addition to the avatar of the user of the imaging apparatus 100. It is preferable that the virtual space management server 20 updates the above output at a determined rate.

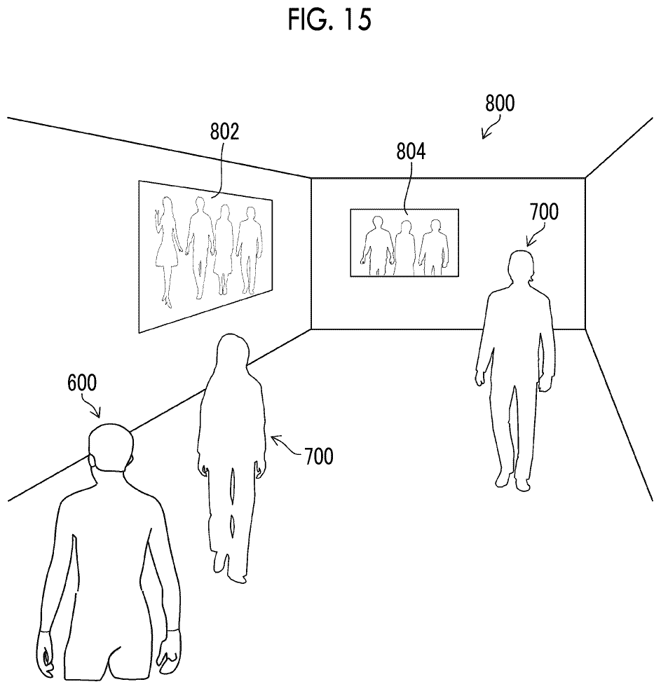

The virtual space management server 20 can cause the user system 10 to display an image indicating a scene of a bird's-eye view, a top view, or the like of the virtual space from a determined position (viewpoint) (for example, a state as shown in FIG. 15 described below), in the same manner as a game played on a smartphone or a PC. The virtual space management server 20 may change the viewpoint (position and/or direction) in accordance with an operation of the user or movement in the virtual space, and may change an output image and/or voice in accordance with the change in the viewpoint.

The user who participates in the virtual space can have a conversation with another user (communication with another user) under the control of the virtual space management unit 22B, and thus a meeting or the like can be held in the virtual space. In addition to the conversation using a normal voice via the microphone 214 and the speaker 216, the conversation in the virtual space can be performed by a method such as a chat using a character with a specific user, a character display in the virtual space using a speech bubble or the like around the avatar (all participants in the virtual space may be able to visually recognize the character), or the like.

It is preferable that the virtual space management server 20 continuously performs “output of scene of virtual space” described above at the determined rate.

### [Display of Avatar and Three-Dimensional Shape Data of Imaging Apparatus]

In a case where the user of the imaging apparatus 100 issues an instruction to transmit the three-dimensional shape data described above, the virtual space management server 20 displays, in the vicinity of the avatar in the virtual space, the three-dimensional shape of the imaging apparatus 100 in association with the avatar (step S150). Specifically, the virtual space management unit 22B and the communication control unit 22A update the virtual space to “state in which the three-dimensional shape of the imaging apparatus 100 is displayed in the vicinity of the avatar in association with the avatar”, and transmit information on the virtual space to the user system 10 to display the information on the display 204 of the goggles 200.

Here, the term “displaying in the vicinity” may be, for example, displaying the three-dimensional shape data within a determined distance from the avatar, or displaying the three-dimensional shape data at a determined part such as a fingertip portion or a chest portion of the avatar. With such a display, it is possible to notify (appeal) another user that the user possesses the imaging apparatus and can capture the virtual image. In a case where the avatar is displayed, the virtual space management server 20 may also display, in the vicinity of the avatar, an ID, nickname, or the like of the user in association with the avatar. Accordingly, a participant in the virtual space can understand who the user represented by the avatar is.

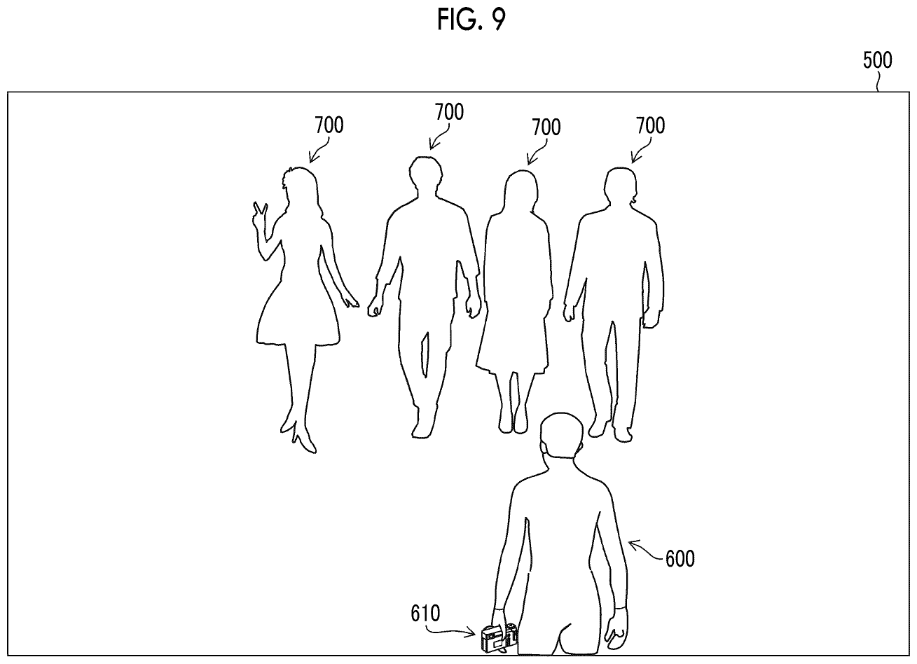

FIG. 9 is a diagram showing a state (virtual live view image 500 described below) in which an avatar 600 of the user (user of the imaging apparatus 100), three-dimensional shape data 610 of the imaging apparatus 100, and avatars 700 of other users are displayed in the virtual space. In the example of FIG. 9, the three-dimensional shape data 610 is displayed on a fingertip portion of the avatar 600. Such display is one aspect of “displaying, in the vicinity of the avatar, the data indicating the three-dimensional shape of the imaging apparatus in association with the avatar”.

The virtual space management server 20 may set, to on or off, the display of the three-dimensional shape of the imaging apparatus 100 or the display of the ID or the like, in response to a user's instruction (operation, motion, voice input, or the like). In a case where the connection between the imaging apparatus 100 and the goggles 200 is interrupted, the imaging apparatus 100 and the goggles 200 may attempt reconnection, or the goggles 200 may notify the virtual space management server 20 of the interruption to delete drawing of data of the imaging apparatus from the virtual space.

### [Transition to Virtual Imaging Mode]

In a case where the mode control unit 106D (processor 106; first processor) and the processor 202 (second processor) determine that “condition set in advance is satisfied” (YES in step S160), the imaging apparatus 100 and the goggles 200 transition to a virtual imaging mode in which the imaging request for the virtual image (second image) and the setting of the second imaging parameter are received (step S170). The second imaging parameter is an imaging condition in a case where the target object in the virtual space is virtually imaged to acquire the virtual image (second image).

### Example of Mode Transition Condition

Examples of a mode transition condition will be described below. However, the mode transition condition in the present invention is not limited to these examples.

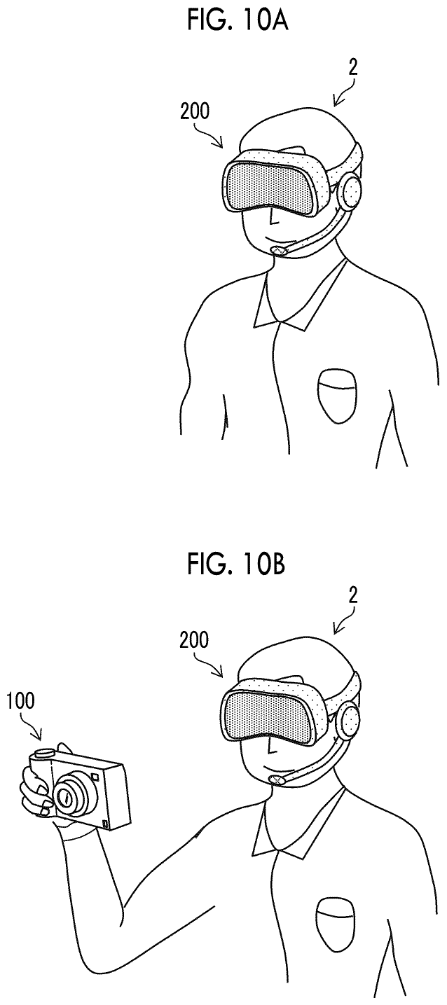

An example of the transition condition is that the user holds the imaging apparatus 100 at a determined position and posture. For example, the user lifts the imaging apparatus 100 near the head, or takes a posture of looking into a finder. FIGS. 10A and 10B are diagrams showing an example in which a mode transitions by the user's motion. FIG. 10A shows a user 2 wearing the goggles 200, and FIG. 10B shows a state in which the user 2 lifts the imaging apparatus 100 near the user's head and takes the posture of looking into the finder. Such a motion of the user 2 can be detected by the motion sensor 118 or the like. In a case where the goggles 200 comprise the motion sensor or the user system 10 includes the motion sensor attached to the hands and feet of the user, the motion may be detected by the motion sensors.

In a case where the motion sensors detect the motion, the mode control unit 106D and the processor 202 determine that “condition set in advance is satisfied”, and the imaging apparatus 100 and the goggles 200 transition to the virtual imaging mode in which the imaging request for the virtual image (second image) and the setting of the imaging parameter (second imaging parameter) of the virtual image are received.

Another example of the transition condition includes that the user shakes the imaging apparatus 100 or performs a motion such as rotation. Further, the example may include that the user performs a determined operation (operation of a specific button or switch, or the like) on the operation unit 110 of the imaging apparatus 100 and/or the user performs a determined operation on the operation unit 206 of the goggles 200.

The transition condition is not limited to the operation on the imaging apparatus 100 or the goggles 200. Still another example of the transition condition may include (1) the processor 202 of the goggles 200 recognizes a specific phrase (for example, “transition to virtual imaging mode” and “take photo”) via the voice recognition via the microphone 214, and (2) another user in the virtual space utters a specific phrase (for example, “let's take group photo”) and the processor 202 performs the voice recognition on the phrase.

The transition condition may be a combination of the above conditions. For example, in a case where another user in the virtual space makes a determined inquiry such as “let's take group photo” and the user of the imaging apparatus 100 makes a determined response such as “sure”, “YES”, or “OK”, or performs a determined motion and/or operation in response to the inquiry, the mode control unit 106D and the processor 202 can determine that “condition set in advance is satisfied”. Similarly, a condition for ending the virtual imaging mode can also be set based on the position and/or posture of the imaging apparatus 100, the operation, the motion, the voice recognition, and a combination thereof.

### [Acquisition and Transmission of Second Imaging Parameter]

In a case where the imaging apparatus 100 and the goggles 200 transition to the virtual imaging mode, the processor 106 and the processor 202 acquire the second imaging parameter and transmit the second imaging parameter to the virtual space management server 20 (step S180 in FIG. 8). The second imaging parameter includes at least one of the focal length, the focusing distance, the shutter speed, the F number, or the image quality. The acquired and transmitted second imaging parameter may be an initial set parameter or a parameter changed from the initial set state (refer to step S200 described below).

### [Switching to First-Person Viewpoint Image in Response to Mode Transition]

Further, in a case where the imaging apparatus 100 and the goggles 200 transition to the virtual imaging mode, the virtual space management server 20 is notified that the mode has transitioned, and the virtual space management server 20 performs an output according to a virtual image capturing mode in response to the notification. Specifically, the virtual space management server 20 switches the display of the display 204 of the goggles 200 to a point of view (first-person viewpoint image of the avatar of the user of the imaging apparatus 100 or the imaging apparatus in the virtual space).

### [Update of First-Person Viewpoint Image (Virtual Live View Image)]

The processor 22 (third processor) of the virtual space management server 20 generates the first-person viewpoint image according to the received second imaging parameter and displays the first-person viewpoint image on the display 204 (step S190). Further, the processor 22 can update the first-person viewpoint image at a determined rate, and can transmit the updated first-person viewpoint image to the user system 10 to display the first-person viewpoint image on the display 204. The image updated in this manner is the same as a live view image in a case where the imaging is performed in the real space, and hereinafter, this image is referred to as “virtual live view image”.

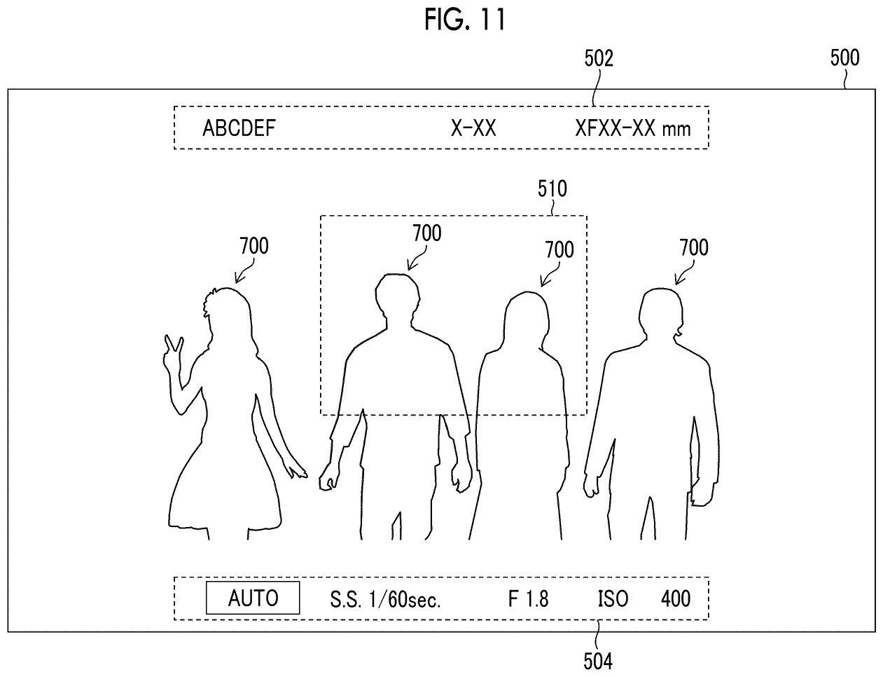

FIG. 11 is a diagram showing a state in which the virtual live view image 500 (image at a certain specific point in time) is displayed on the display 204. The virtual live view image 500 includes a region 502 and a region 504. A brand name, model number, and feature of a mounted optical system of the imaging apparatus indicated by the three-dimensional shape data (model number and focal length in the example of FIG. 11) are displayed in the region 502, and the second imaging parameter set at a point in time of the display is displayed in the region 504. In the example of FIG. 11, the white balance is AUTO (automatic), the shutter speed is 1/60 sec, the stop is 1.8, and the ISO sensitivity is 400. Further, the virtual live view image 500 displays the avatars 700 of other users (four persons).

### [Update of Virtual Live View Image in Response to Movement or Change in Direction]

The processor 106 of the imaging apparatus 100 comprises the motion sensor 118 and the measurement unit 106C (first processor, processor), which configure a measurement unit that measures the imaging position (first imaging position) and the imaging direction (first imaging direction) of the imaging apparatus 100 in the real space. The measurement unit 106C sets an imaging position (second imaging position) and an imaging direction (second imaging direction) of the imaging apparatus in the virtual space, based on the measured first imaging position and first imaging direction, and transmits information indicating the second imaging position and information indicating the second imaging direction to the virtual space management server 20. The processor 22 (mainly virtual space management unit 22B and virtual image generation unit 22C; third processor) of the virtual space management server 20 can generate the virtual live view image according to the second imaging position and the second imaging direction.

Further, in a case where the measured first imaging position and first imaging direction are changed, the processor 106 (first processor) transmits, to the virtual space management server 20, information indicating the changed second imaging position and information indicating the changed second imaging direction. The processor 22 can generate a virtual live view image corresponding to the changed second imaging position and second imaging direction (steps S190 and S210 in FIG. 7).

As described above, in the imaging system 1 according to the present embodiment, in a case where the user moves in the real space or changes an orientation of the imaging apparatus, the avatar of the user and the imaging apparatus in the virtual space are also moved accordingly, and the orientation of the imaging apparatus in the virtual space is also changed. Accordingly, the user can move to a desired place in the virtual space and capture an image in a desired direction.

The information on the first imaging position and the first imaging direction may be transmitted from the user system 10 to the virtual space management server 20, and the virtual space management server 20 may calculate and set the second imaging position and the second imaging direction. With the calculation and setting of the second imaging position and the second imaging direction by the virtual space management server 20 in this manner, it is possible to reduce the load on the user system 10.

### [Change of Second Imaging Parameter]

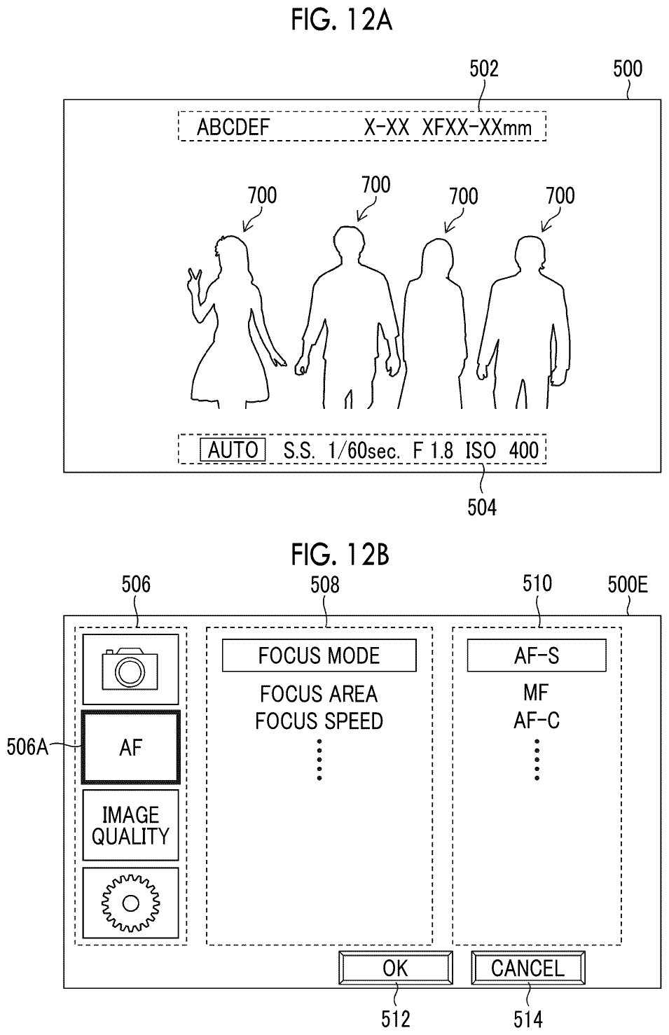

The second imaging parameter described above can be changed in response to the user's instruction. Specifically, the imaging parameter setting unit 106B (first processor) of the imaging apparatus 100 can set the second imaging parameter in response to an operation on the member for imaging parameter setting (setting instruction). The button, the dial, or the like (not shown) configuring the operation unit 110 can be used as “member for imaging parameter setting”, and the second imaging parameter may be set and changed by a member and an operation common to a case of the setting of the first imaging parameter in the imaging of the real image. With employment of such an aspect, it is possible to improve the operability of the virtual image capturing. Further, in a case where the display 108 of the imaging apparatus 100 is a touch panel type display, the display 108 may be used as “member for imaging parameter setting”. Further, the second imaging parameter may be set and changed via the display 204 of the goggles 200 (refer to the description of FIGS. 12A and 12B described below). Furthermore, the second imaging parameter may be set and changed by a user's motion (gesture) or the voice input.

In a case where the operation of changing the second imaging parameter on the member for imaging parameter setting (setting instruction) is performed (YES in step S200), the imaging parameter setting unit 106B and the communication control unit 106E (first processor) transmit the second imaging parameter, which is changed (subjected to setting instruction), to the virtual space management server 20 via the goggles 200 (server connection device). The above Web API can be used for the transmission. The virtual space management server 20 reflects the change of the second imaging parameter in the virtual live view image (described below).

### [Real Parameter and Virtual Parameter]

The second imaging parameter (imaging parameter used for imaging virtual image) described above may be a parameter (real parameter) realized by the real imaging optical system provided in the imaging apparatus 100, or may be a parameter (virtual parameter) implemented by a virtual imaging optical system virtually provided in the imaging apparatus 100. An example of setting the real parameter includes that, in a case where the zoom lens having the focal length of 25 mm to 200 mm is actually mounted on the imaging apparatus 100, the focal length is set in a range of 25 mm to 200 mm according to the rotation of the lens barrel. In a case where the virtual image is captured, unlike a case where the real image is captured, an image formed by the imaging optical system 102 of the imaging apparatus 100 is not acquired. The rotation operation of the lens barrel in the above example is for setting the second imaging parameter.

On the other hand, a parameter (virtual parameter) that cannot be obtained by the optical system connected to the imaging apparatus 100 may be set as the second imaging parameter. In the above example, in a case where the focal length of the zoom lens actually mounted on the imaging apparatus 100 is 25 mm to 200 mm, the focal length may be changed in a range of 10 mm to 25 mm or 200 mm to 300 mm. Further, even in a case of a lens that does not actually exist in the real world, in a case where lens data corresponding to the lens is present, the focal length may be determined according to the lens data (use of virtual lens). The same applies to other imaging parameters other than the focal length. With the setting of such a virtual parameter as the second imaging parameter, it is possible to improve the convenience of the virtual image capturing and to provide a way of enjoying a special lens unique to the virtual space.

### [Setting of Second Imaging Parameter in Virtual Space]

The setting instruction (setting or change) of the second imaging parameter related to the capturing of the virtual image may be performed in the virtual space. FIGS. 12A and 12B are diagrams showing a scene in which the second imaging parameter is set or changed in the virtual space. FIG. 12A shows a state in which the imaging apparatus 100 and the goggles 200 transition to the virtual image capturing mode and the display 204 displays the virtual live view image 500. The display of the display 204 transitions from this state to a setting screen of the second imaging parameter in response to the user's instruction (determined operation, motion, voice, or the like).

FIG. 12B shows a state in which the virtual space management server 20 causes the display 204 to display the setting screen (screen displayed in virtual space) of the second imaging parameter. The setting screen of the second imaging parameter includes regions 506, 508, and 510, an OK button 512 and a cancel button 514. A higher-level item of a menu is displayed as an icon in the region 506, and a lower-level (specific) item of the menu is displayed in the regions 508 and 510. The example shown in FIG. 12B is a state in which focus mode setting and AF-S(single AF) are selected in autofocus (button 506A) setting. In such a screen, processing such as selection or determination of the menu, and a setting end can be performed in response to the user's motion (gesture), the voice recognition, and the like.

The setting screen of the second imaging parameter may be the same as or similar to a real setting screen (screen displayed on the display 108 in a case where the first imaging parameter, which is an imaging condition of real imaging, is set) of the imaging apparatus 100, or may be a unique screen. In a case where the same or similar screen as the real setting screen is used, information on an imaging parameter setting screen of the imaging apparatus 100 may be transmitted to the virtual space management server 20, and the virtual space management server 20 may display the setting screen in the virtual space based on the information.

The virtual space management server 20 only needs to show (transmit) the setting screen of the second imaging parameter to the user of the imaging apparatus 100, and there is no need to show the setting screen to other users. Further, while a case has been described in which the virtual space management server 20 displays the setting screen, the processor 202 of the goggles 200 may generate the setting screen and display the setting screen on the display 204 as long as the setting screen is not displayed to other users.

In a case where the user wears the goggles 200, there is a possibility that the user may have difficulty in operating the operation unit 110 of the imaging apparatus 100 or the operation unit 206 of the goggles 200 because a field of view is obstructed. However, with the operation in the virtual space via the display 204, the user can easily set the second imaging parameter in a state of wearing the goggles 200.

### [Update of Virtual Live View Image According to Change of Second Imaging Parameter]

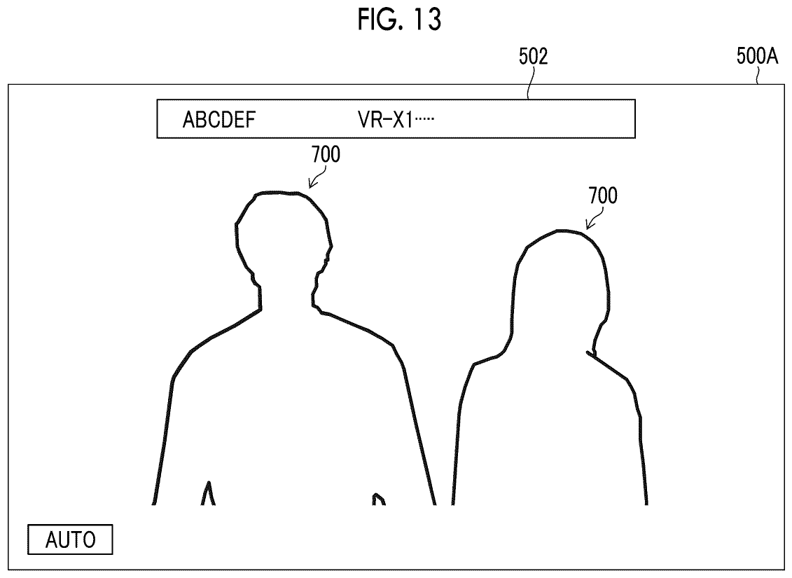

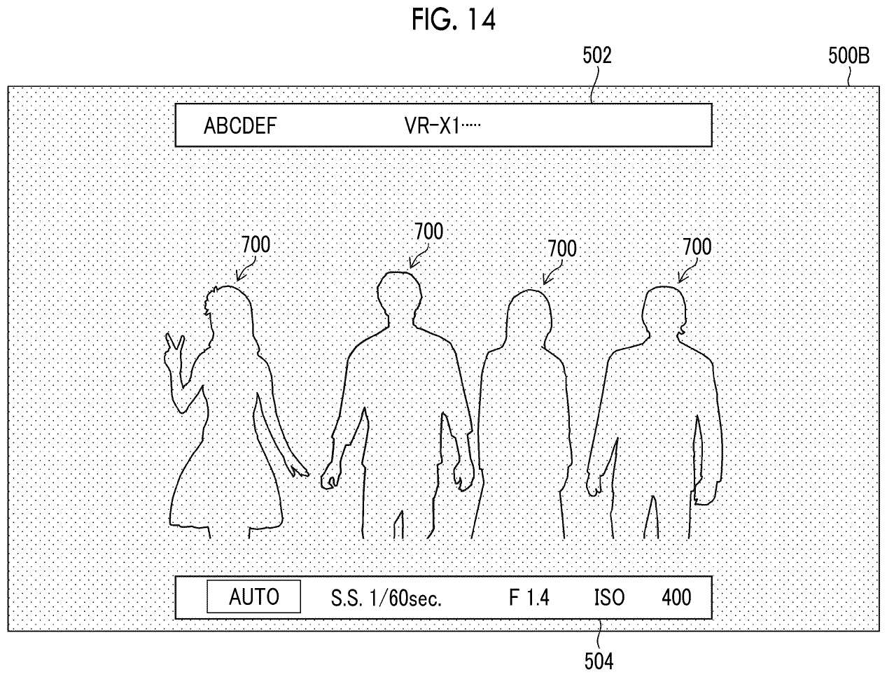

The processor 22 (mainly communication control unit 22A, virtual image generation unit 22C, and virtual image display control unit 22D; third processor) of the virtual space management server 20 displays, on the display 204 of the goggles 200, the virtual live view image according to the change of the second imaging parameter (step S210). FIG. 13 is a diagram showing an example (virtual live view image 500A) in a case where the focal length is changed (in a case where the region 510 in FIG. 11 is zoomed), and FIG. 14 is a diagram showing an example (virtual live view image 500B) in a case where exposure is changed (in a case where the F number is increased). The processor 22 and the display 204 continue (update at determined rate) the display of the virtual live view image until the imaging request for the virtual image is made (while NO in step S220).

### [Acquisition and Output of Virtual Image]

In a case where the second imaging instruction is issued (YES in step S220), the imaging request for at least the virtual image is transmitted from the user system 10 to the virtual space management server 20. In a case where the latest second imaging parameter has not been transmitted, the second imaging parameter may be transmitted together with the imaging request. The second imaging instruction may be an operation on the operation unit 110 (release switch or the like used for real imaging) and/or the operation unit 206, or may be a request (for example, utterance of a specific phrase such as “virtual image capturing”) by a determined motion (gesture or the like) or voice of the user.

The processor 22 (mainly virtual image generation unit 22C; third processor) of the virtual space management server 20 generates the virtual image (second image) based on the set second imaging parameter in response to the imaging request, and transmits the virtual image to the goggles 200 (server connection device, image output device). The goggles 200 receive image data of the virtual image from the virtual space management server 20 via the network NW (communication line) (acquisition of virtual image), and display the virtual image corresponding to at least the received image data on the display 204 (output device, image output device) (step S230). The virtual space management server 20 may transmit, to the goggles 200, a capturing date and time of the virtual image or a place in the virtual space, the second imaging parameter, and information (accessory information of virtual image) such as identification information or ID of the user who has participated in the imaging, and the goggles 200 may output these pieces of information together with the virtual image to the display 204 or the like.

The virtual space management server 20 may generate, as the virtual image, a still image or a moving image. Which image is generated by the virtual space management server 20 can be determined in response to the user's instruction (operation on operation member such as release button (not shown), user's motion, voice input, or the like), and whether the image is a still image or a moving image may be included in the imaging request or the second imaging parameter. Further, the virtual image may include voice data. The recording control unit 106G (processor 106; first processor) of the imaging apparatus 100 stores the acquired virtual image in the memory card 116 (output device), in response to the user's instruction (operation on the operation unit 110, motion, voice input, or the like). The stored virtual image can be displayed on the display 108. Further, in a case where the imaging apparatus 100 is a printer-equipped camera, the virtual image may be printed (output) by the printer (image output device). The recording control unit 106G may also perform the output such as storing or displaying of the accessory information described above in the recording medium such as the memory card 116, or printing of the accessory information together with the virtual image. In a case where the accessory information is output, it is preferable that the accessory information is associated with the virtual image.

The goggles 200 end the display of the virtual image in response to the user's instruction (operation on the operation unit 110 and/or the operation unit 206, user's motion, voice, or the like), and return to the display of the virtual live view image.

In a case where the user issues an instruction (instruction by operation, motion, voice, or the like) to end the virtual image capturing (YES in step S240), the imaging apparatus 100 and the goggles 200 end the state in which the first-person viewpoint image (virtual live view image) is output and the processing returns to step S150 (state in which the scene of the virtual space is output). In a case where there is no instruction to end the virtual image capturing (NO in step S240; in a case where the virtual image capturing is continued), the processing returns to step S200.

### [Exhibition or the Like of Virtual Image]

The user can exhibit the acquired virtual image in the virtual space. There may be an exhibition of the image itself or an exhibition of an object on which the image is printed. FIG. 15 is a diagram showing a scene in which the virtual image is exhibited in the virtual space. In the example of FIG. 15, virtual images 802 and 804 are displayed on a wall of a virtual image exhibition room 800 provided in the virtual space. The scene of such a virtual image exhibition room 800 is generated by the virtual space management server 20 (processor 22; third processor), in the same manner as described above for step S150 in FIG. 7, and is output to the goggles 200.

The virtual image displayed in this manner may be obtained (downloaded) by a user who desires the virtual image. In a case where the user's instruction (operation on the operation unit of the imaging apparatus 100, determined motion, utterance of determined phrase, or the like) is issued for the exhibition and obtainment of the virtual image, the virtual space management server 20 is notified of the instruction, and the virtual space management server 20 exhibits and/or provides the virtual image in response to the notification (to user system of user who desires the virtual image). Regarding the image exhibition, in addition to the virtual image, the real image may be uploaded from the imaging apparatus 100 to the virtual space management server 20 to be displayed in the exhibition room in the virtual space. Further, not only the image but also a document, a table, or the like may be displayed in the virtual space.

As described above, with the imaging system 1 according to the present embodiment, it is possible to provide the user with the way of enjoying not only the capturing of the virtual image but also the exhibition (display) or provision of the virtual image or the like.

As described above, with the imaging system 1 of the present embodiment, it is possible to capture the real image and the virtual image using the imaging apparatus 100 and to display the data indicating the avatar of the user and the three-dimensional shape of the imaging apparatus in the virtual space.

### [Applied Aspect of Virtual Image Capturing]

In the capturing of the virtual image, it is considered that the user “wants to image the virtual image including the user oneself (own avatar) in the virtual space (wants to image so-called “selfie” or “group photo”)”, in the same manner as the imaging in the real space. An embodiment in consideration of such circumstances will be described below.

### [Fixation of Imaging Position and Imaging Direction in Virtual Space]

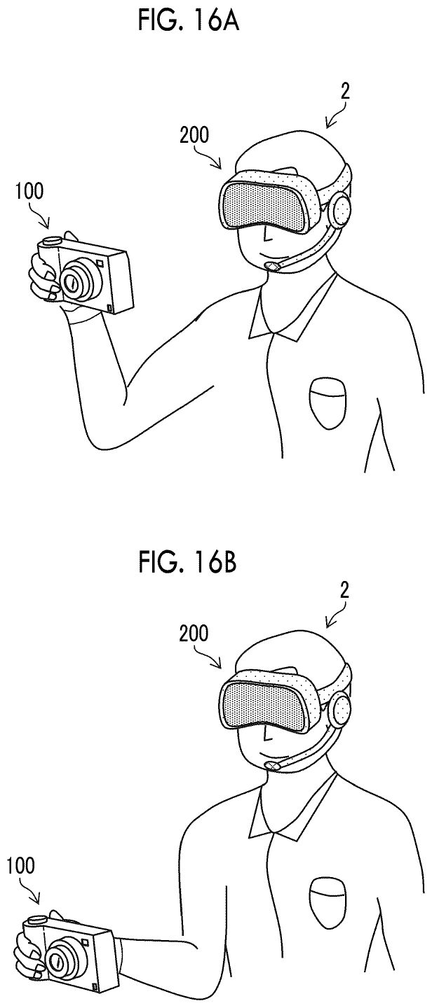

FIGS. 16A and 16B are diagrams showing a scene of fixation of the imaging position and the imaging direction in the virtual space. FIG. 16A shows a scene in which the user 2 takes a posture of looking into the finder with the imaging apparatus 100 at the vicinity of the head (or at the vicinity of the goggles 200), and thus “condition set in advance” described above is satisfied and then the imaging apparatus 100 and the goggles 200 transition to the virtual imaging mode. In a case where the user issues a determined instruction in this state, the processor 106 (processor, first processor) causes the virtual space management server 20 to fix the imaging position (second imaging position) and the imaging direction (second imaging direction) in the virtual space, in response to the user's instruction to the imaging apparatus 100. FIG. 16B shows a state in which the imaging position and the imaging direction are fixed, and in this state, the imaging position and the imaging direction of the virtual live view image output to the display 204 of the goggles 200 and the virtual image to be captured are fixed. Thus, the user can lower the imaging apparatus 100 (the same posture does not have to be maintained).

The “instruction” to fix the imaging position and the imaging direction may be a determined operation on a member of the operation unit 110 and/or the operation unit 206 or the display 108, may be a specific motion (waving a hand or a foot, or the like) by the user, or may be an instruction by voice (utterance of a specific phrase such as “fix position” or “fix direction”). The user's motion can be detected by the motion sensor 118 and the measurement unit 106C, and the instruction by voice can be input via the microphone 214. Two or more of the operation, the motion, and the voice may be combined as the “instruction”. These instructions can be similarly performed in a case where the fixation is released.

In a case where the imaging position and the imaging direction in the virtual space are fixed, the user can move to any place to capture the virtual image, and can also capture an image of the user oneself. In a case where the imaging position and the imaging direction are fixed, the user system 10 (imaging apparatus 100 and goggles 200) may automatically perform self-timer imaging described below.

### [Self-Timer Imaging of Virtual Image]

The processor 106 (mainly image acquisition unit 106A and communication control unit 106E; first processor) transmits, to the virtual space management server 20, the imaging request for the second image after a determined time has elapsed from the issuance of the second imaging instruction. With such “self-timer imaging”, it is possible to easily image the self-portrait or a group photo (virtual image) including oneself. The “determined time (time of self-timer)” can be set by the operation on the operation unit 110 and/or the operation unit 206, the user's motion, the voice input, or a combination thereof. In a case where the imaging apparatus 100 comprises an operation member such as a switch or a lever for the self-timer imaging in the real space, the operation member may be commonly used in the capturing of the virtual image.

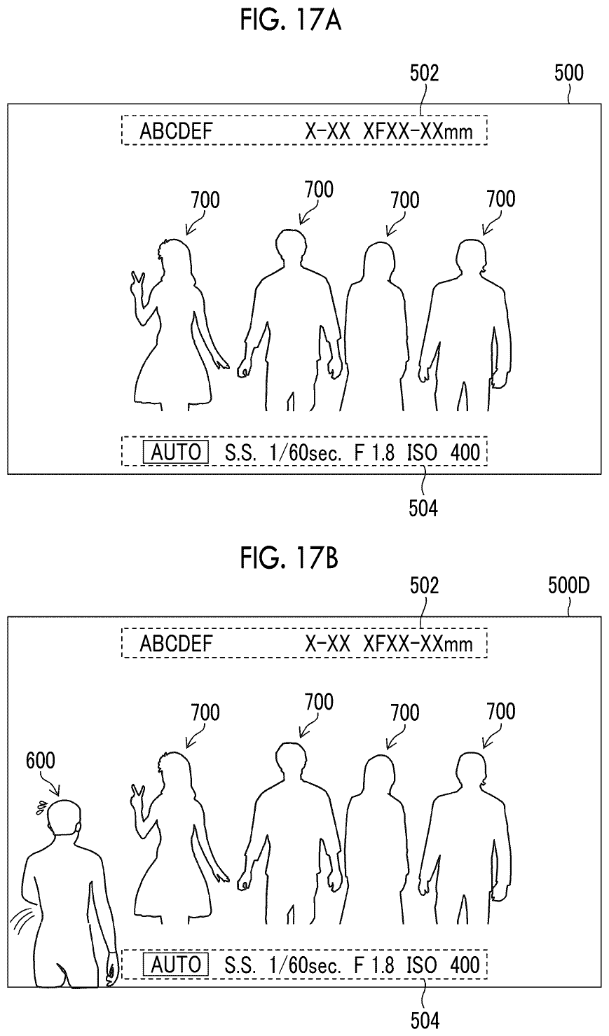

FIGS. 17A and 17B are diagrams showing a scene of imaging using a self-timer function. FIG. 17A shows a state in which the virtual live view image 500 is displayed on the display 204 (the same as FIG. 11), and in this state, the imaging position and the imaging direction are assumed to be fixed. In this state, the user can move away from a position of the imaging apparatus in the virtual space, and can come into the angle of view of a virtual live view image 500D as shown in FIG. 17B. In (b) of FIG. 17, the avatar 600 is an avatar of the user oneself of the imaging apparatus 100, and the avatars 700 are avatars of other users.

FIGS. 18A to 18E are other diagrams showing the scene of imaging using the self-timer function. FIG. 18A shows a state in which the imaging position and the imaging direction are fixed in the virtual image capturing mode and the user oneself comes into the angle of view (one frame of the virtual live view image). FIG. 18B shows a state in which the user performs a motion (motion of raising the right hand and swinging the hand left and right; one aspect of the imaging instruction) for transitioning to a self-timer mode. The actual motion of the user is reflected in the motion of the avatar 600. FIG. 18C shows a state in which the mode transitions to the self-timer mode, and FIG. 18D shows a state in which the user performs a motion (motion of raising the left hand and swinging the hand back and forth; one aspect of the imaging instruction) for setting the self-timer. In FIG. 18D, the actual motion of the user is reflected in the motion of the avatar 600, in the same manner as FIG. 18B. FIG. 18E shows a scene in which the virtual image is captured after a timer time (determined time) has elapsed from the self-timer setting.

In the imaging system 1 of the present embodiment, with such a self-timer function, the user can enjoy taking a self-portrait or a group photo with other users. The instruction for transitioning to the self-timer mode or the imaging may be not only an instruction from the user of the imaging apparatus 100 but also an instruction from another user (motion of avatar, voice, or the like reflecting a motion of another user).

### Modification Example of User System

In the first embodiment described above, the user system 10 is configured by using the goggles 200 as the server connection device, but the configuration of the user system is not limited to such an aspect. FIG. 19 is a diagram showing a modification example of the user system. In a user system 10A shown in FIG. 19, a smartphone 400 is used as “server connection device”, and a display 410 of the smartphone 400 is used for displaying the virtual image or the like. The smartphone 400 can be connected to the imaging apparatus 100 by wireless communication such as Bluetooth, and the smartphone 400 is connected to the router 300 by wireless communication such as Wi-Fi to communicate with the virtual space management server 20. Instead of the smartphone 400, a device such as a personal computer or a tablet terminal that is connectable to the network may be used as the server connection device.

In these aspects, although the sense of immersion in the virtual space is reduced, the user can easily perform the capturing of the virtual image or the like without obstruction of the field of view of the user. In a case where a device with an in-camera is used as the server connection device, the user's motion may be detected from an image acquired by the in-camera of the device, or information such as “facial expression” or “emotion” may be provided to the avatar based on information extracted from the image.

### Second Embodiment

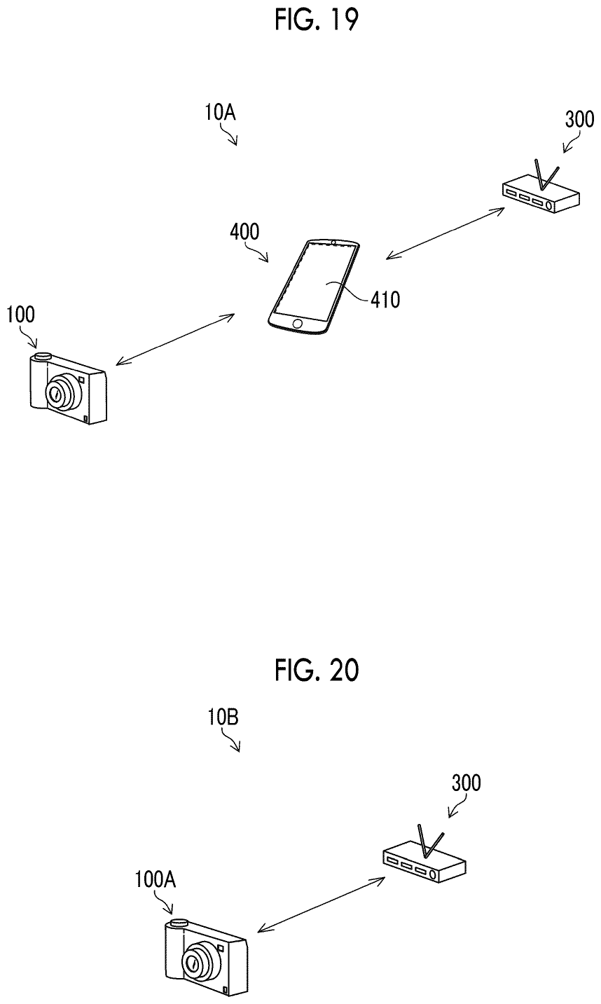

In the first embodiment and the modification example described above, the imaging apparatus and the server connection device constitute the user system, but the imaging apparatus alone may constitute the user system (the imaging apparatus 100A may serve as both “imaging apparatus” and “server connection device”). FIG. 20 is a diagram showing a configuration of a user system according to a second embodiment. In the second embodiment, the imaging apparatus 100A alone constitutes a user system 10B. In the user system 10B, the imaging apparatus 100A is connected to the virtual space management server 20 by wireless communication such as Wi-Fi to perform the setting of the second imaging parameter, the capturing of the virtual image, and the like.

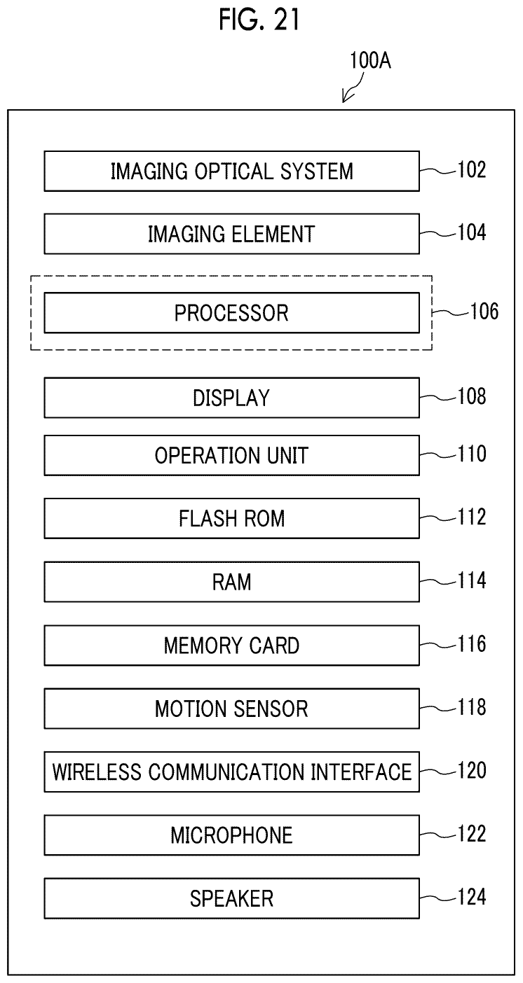

FIG. 21 is a diagram showing a configuration of the imaging apparatus 100A according to the second embodiment. As shown in FIG. 21, the imaging apparatus 100A comprises a microphone 122 and a speaker 124 in addition to the configuration of the imaging apparatus 100 according to the first embodiment, and can input and output a voice by these devices (a processor 107 is assumed to have the voice recognition function). Further, the display 108 can be used to set the second imaging parameter, display the virtual image, and the like. In such an aspect, although the sense of immersion in the virtual space is reduced as in the above modification example, but the user can easily perform the capturing of the virtual image or the like without obstruction of the field of view of the user.

The embodiments and modification examples of the present invention have been described above, but the present invention is not limited to the aspects, and various modifications can be made.

### EXPLANATION OF REFERENCES

1: imaging system
2: user
10: user system
10A: user system
10B: user system
20: virtual space management server
22: processor
22A: communication control unit
22B: virtual space management unit
22C: virtual image generation unit
22D: virtual image display control unit
28: database
100: imaging apparatus
100A: imaging apparatus
102: imaging optical system
104: imaging element
106: processor
106A: image acquisition unit
106B: imaging parameter setting unit
106C: measurement unit
106D: mode control unit
106E: communication control unit
106F: display control unit
106G: recording control unit
107: processor
108: display
110: operation unit
116: memory card
118: motion sensor
120: wireless communication interface
122: microphone
124: speaker
200: goggles
202: processor
204: display
206: operation unit
212: wireless communication interface
214: microphone
216: speaker
218: microphone
220: speaker
300: router
400: smartphone
410: display
500: virtual live view image
500A: virtual live view image
500B: virtual live view image
500D: virtual live view image
502: region
504: region
506: region
506A: button
508: region
510: region
512: OK button
514: cancel button
600: avatar
610: three-dimensional shape data
700: avatar
800: virtual image exhibition room
802: virtual image
804: virtual image
S100 to S240: each step of imaging method

What is claimed is:

1. An imaging apparatus comprising:
a processor,
wherein the processor is configured to:
set a first imaging parameter that is an imaging parameter in a case where a target object in a real space is imaged by using an imaging optical system and an imaging element to acquire a first image, and a second imaging parameter that is an imaging parameter in a case where a target object in a virtual space is virtually imaged to acquire a second image; and
acquire the first image based on the first imaging parameter in response to a first imaging instruction,
in which the imaging apparatus transitions to, in a case where a condition set in advance is satisfied, a virtual imaging mode in which an imaging request for the second image and setting of the second imaging parameter are received, and
in the virtual imaging mode, the processor is configured to:
transmit, in a case where a setting instruction of the second imaging parameter is issued, the second imaging parameter subjected to the setting instruction to a virtual space management server that manages the virtual space, via a communication line;
transmit at least the imaging request for the second image to the virtual space management server via the communication line in response to a second imaging instruction;
receive, from the virtual space management server, image data of the second image corresponding to the transmitted second imaging parameter via the communication line; and
cause an image output device to output the second image corresponding to at least the image data.

2. The imaging apparatus according to claim 1,
wherein the processor is configured to:
set the second imaging parameter in response to an operation on a member for imaging parameter setting; and
transmit, in a case where an operation of changing the second imaging parameter is performed on the member for imaging parameter setting, the changed second imaging parameter to the virtual space management server.

3. The imaging apparatus according to claim 1,
wherein the processor is configured to:
set a real parameter implemented by a real imaging optical system provided in the imaging apparatus or a virtual parameter implemented by a virtual imaging optical system virtually provided in the imaging apparatus as the second imaging parameter.

4. The imaging apparatus according to claim 1, comprising:
a measurement unit that measures a first imaging position and a first imaging direction of the imaging apparatus in the real space,
wherein the processor is configured to:
set a second imaging position and a second imaging direction of the imaging apparatus in the virtual space based on the measured first imaging position and first imaging direction;
transmit, to the virtual space management server, information indicating the second imaging position and information indicating the second imaging direction; and
receive, from the virtual space management server, image data of the second image corresponding to the second imaging position and the second imaging direction.

5. The imaging apparatus according to claim 4,
wherein the processor is configured to:
transmit, in a case where the measured first imaging position and first imaging direction are changed, information indicating the changed second imaging position and information indicating the changed second imaging direction to the virtual space management server.

6. The imaging apparatus according to claim 4,
wherein the processor is configured to:
cause the virtual space management server to fix the second imaging position and the second imaging direction in the virtual space in response to an instruction of a user to the imaging apparatus.

7. The imaging apparatus according to claim 1,
wherein the processor is configured to:
transmit the imaging request for the second image to the virtual space management server after a determined time has elapsed from issuance of the second imaging instruction.

8. The imaging apparatus according to claim 1, comprising:
a first storage unit that stores avatar information indicating an avatar of a user of the imaging apparatus,
wherein the processor is configured to:
transmit the stored avatar information to the virtual space management server to cause the virtual space management server to display the avatar of the user in the virtual space.

9. The imaging apparatus according to claim 8, comprising:
a second storage unit that stores data indicating a three-dimensional shape of the imaging apparatus,
wherein the processor is configured to:
transmit the stored data to the virtual space management server to cause the virtual space management server to display the three-dimensional shape of the imaging apparatus in a vicinity of the avatar in the virtual space in association with the avatar.

10. The imaging apparatus according to claim 1,
wherein the second image is a still image or a moving image.

11. An imaging system comprising:
an imaging apparatus; and
a server connection device,
wherein the imaging apparatus includes a first processor,
the first processor is configured to:
set a first imaging parameter that is an imaging condition in a case where a target object in a real space is imaged by using an imaging optical system and an imaging element to acquire a first image, and a second imaging parameter that is an imaging condition in a case where a target object in a virtual space is virtually imaged to acquire a second image; and
acquire the first image based on the first imaging parameter in response to a first imaging instruction,
in which the imaging apparatus and the server connection device transition to, in a case where a condition set in advance is satisfied, a virtual imaging mode in which an imaging request for the second image and setting of the second imaging parameter are received,
in the virtual imaging mode, the first processor is configured to:
transmit, in a case where a setting instruction of the second imaging parameter is issued, the second imaging parameter subjected to the setting instruction to a virtual space management server that manages the virtual space, via the server connection device; and
transmit at least the imaging request for the second image to the virtual space management server via the server connection device in response to a second imaging instruction,
the server connection device includes a second processor and an image output device, and
in the virtual imaging mode, the second processor is configured to:
transmit, to the virtual space management server, the imaging request for the second image and the second imaging parameter via a communication line;
receive, from the virtual space management server, image data of the second image corresponding to the transmitted second imaging parameter via the communication line; and
cause the image output device to output the second image corresponding to at least the received image data.

12. The imaging system according to claim 11,
wherein the server connection device is a goggle-type device worn by a user, and includes a display device that displays the second image as the image output device.

13. The imaging system according to claim 11, further comprising:
the virtual space management server,
wherein the virtual space management server
generates the image data of the second image corresponding to the second imaging parameter in accordance with the imaging request and the imaging condition of the second image received from the server connection device, and
transmits the generated image data to the server connection device.

14. The imaging system according to claim 13,
wherein the virtual space management server displays the second image in the virtual space in response to an operation of a user of the imaging apparatus.

15. The imaging system according to claim 13,
wherein the virtual space management server transmits the image data of the second image generated in response to the imaging request received from one imaging apparatus connected to the virtual space management server, in response to a request from another imaging apparatus connected to the virtual space management server, to the other imaging apparatus.

16. An imaging method executed by an imaging apparatus including a processor, the imaging method comprising:
by the processor,
setting a first imaging parameter that is an imaging parameter in a case where a target object in a real space is imaged by using an imaging optical system and an imaging element to acquire a first image, and a second imaging parameter that is an imaging parameter in a case where a target object in a virtual space is virtually imaged to acquire a second image; and
acquiring the first image based on the first imaging parameter in response to a first imaging instruction,
in which the imaging apparatus transitions to, in a case where a condition set in advance is satisfied, a virtual imaging mode in which an imaging request for the second image and setting of the second imaging parameter are received; and
in the virtual imaging mode, by the processor,
transmitting, in a case where a setting instruction of the second imaging parameter is issued, the second imaging parameter subjected to the setting instruction to a virtual space management server that manages the virtual space, via a communication line;
transmitting the imaging request for the second image to the virtual space management server via the communication line in response to a second imaging instruction;
receiving, from the virtual space management server, image data of the second image corresponding to the transmitted second imaging parameter via the communication line; and
causing an image output device to output the second image corresponding to at least the image data.

17. An imaging method executed by an imaging system including an imaging apparatus including a first processor, and a server connection device including a second processor and an image output device, the imaging method comprising:
by the first processor,
setting a first imaging parameter that is an imaging condition in a case where a target object in a real space is imaged by using an imaging optical system and an imaging element to acquire a first image, and a second imaging parameter that is an imaging condition in a case where a target object in a virtual space is virtually imaged to acquire a second image; and
acquiring the first image based on the first imaging parameter in response to a first imaging instruction,
in which the imaging apparatus and the server connection device transition to, in a case where a condition set in advance is satisfied, a virtual imaging mode in which an imaging request for the second image and setting of the second imaging parameter are received;
in the virtual imaging mode, by the first processor,
transmitting, in a case where a setting instruction of the second imaging parameter is issued, the second imaging parameter subjected to the setting instruction to a virtual space management server that manages the virtual space, via the server connection device; and
transmitting the imaging request for the second image to the virtual space management server via the server connection device in response to a second imaging instruction; and
in the virtual imaging mode, by the second processor,
transmitting, to the virtual space management server, the imaging request for the second image via a communication line;
receiving, from the virtual space management server, image data of the second image corresponding to the second imaging parameter via the communication line; and
causing the image output device to output the second image corresponding to at least the received image data.
